(19) United States
(12) Patent Application Publication
(10) Pub. No.: US 2011/0019800 A1
(43) Pub. Date: Jan. 27, 2011

(54) X-RAY DETECTOR FOR RECORDING X-RAY IMAGES AND X-RAY RECORDING SYSTEM

(76) Inventor: Martin Spahn, Erlangen (DE)

Correspondence Address: King & Spalding LLP, 401 Congress Avenue, Suite 3200, Austin, TX, 78701, US

(21) Appl. No.: 12/839,671

(22) Filed: Jul. 20, 2010

(30) Foreign Application Priority Data
Jul. 24, 2009 (DE) 10 2009 034 648.1

(51) Int. Cl. H05G 1/64

(52) U.S. Cl. 378/98

(57) ABSTRACT

An X-ray detector (10) for recording digital X-ray images, has a mobile design, with an energy supply unit (14) that has at least one chargeable high-power capacitor (15).

### CROSS-REFERENCE TO RELATED APPLICATIONS

This application claims priority to DE Patent Application No. 2009 034 648.1.0 filed Jul. 24, 2009. The contents of which is incorporated herein by reference in its entirety.

### TECHNICAL FIELD

The invention relates to an X-ray detector for recording X-ray images and an X-ray recording system with an X-ray detector.

### BACKGROUND

In digital X-ray imaging, X-ray detectors, designed as solid-state detectors, for recording X-ray images of an examination object are known in which X-ray radiation is converted into electrical charge by a scintillator or a direct-conversion layer, and subsequently read out electronically by means of active readout matrices. Subsequently, the image data representing the examination results is transmitted to an evaluation and display device, and processed further in order to generate an image (See the article “Flachbilddetektoren in der Röntgendiagnostik” [Flat-panel detectors in X-ray diagnostics] by M. Spahn, V. Heer, R. Freytag, published in the Journal Radiologe [Radiologist] 43, 2003, pages 340 to 350).

By way of example, DE 101 18 745 C2 has disclosed mobile, wireless solid-state detectors that have an energy supply in the form of a battery or a simple rechargeable accumulator. The solid-state detector must regularly be inserted into a charging station and left there for a few hours in order to charge the accumulator, the charging being brought about via a plug-in connection or an inductive connection.

### SUMMARY

According to various embodiments, the usability of such X-ray detectors, more particularly of such mobile, wireless solid-state detectors can be simplified or improved.

According to an embodiment, an X-ray detector for recording digital X-ray images, may have a mobile design, with an energy supply unit that has at least one chargeable high-power capacitor.

According to a further embodiment, the X-ray detector can have a wireless data transmission unit. According to a further embodiment, the energy supply unit may have at least one energy transmission unit for the connection to an external energy transmission system. According to a further embodiment, the X-ray detector may have a wireless design. According to a further embodiment, the X-ray detector may have a photovoltaic energy generation device, more particularly at least one solar cell.

According to another embodiment, an X-ray recording system may have an X-ray detector as described above, an X-ray source for emitting X-ray radiation and an energy transmission system for transmitting energy to the energy supply unit of the X-ray detector by means of the energy transmission unit.

According to a further embodiment of the X-Ray recording system, the energy transmission system can be formed by a charging station. According to a further embodiment of the X-Ray recording system, the energy transmission system can be arranged in a Bucky drawer or a wall stand.

### BRIEF DESCRIPTION OF THE DRAWINGS

Herein below, various embodiments are illustrated schematically in more detail in the drawings, without this limiting the invention to these exemplary embodiments. In the drawing,

FIG. 1 shows a section through an X-ray detector according to various embodiments with a chargeable high-power capacitor,

FIG. 2 shows a section through an X-ray detector according to various embodiments with a chargeable high-power capacitor and a solar panel, and

FIG. 3 shows a view of an X-ray recording system with an X-ray detector according to various embodiments.

### DETAILED DESCRIPTION

The X-ray detector according to various embodiments for recording digital X-ray images may have a mobile design and an energy supply unit that has at least one chargeable high-power capacitor. Compared to conventional accumulators, high-power capacitors are advantageous in that their charging times are very short (seconds to a few minutes), their service lives are virtually limitless, there is no risk of an explosion and they do not generate heat. Disadvantages usually accrue due to heat generation—on the one hand, there is a negative influence on the image quality as a result of a global or local temperature increase in the scintillator or in the direct converter and the photon-optical layer and, on the other hand, there is a risk to persons from heat in the case of X-ray detectors with direct human contact. These disadvantages are dispensed with as a result of the X-ray detector according to various embodiments. The quick charging time of the high-power capacitor ensures availability of the X-ray detector after emptying of the energy supply unit within a very short timeframe, e.g. a few seconds to a few minutes, compared to a few hours in the case of conventional equipment with simple accumulators. This continuous availability further amplifies the actual advantage of a mobile, wireless X-ray detector, namely its functionality without bothersome cables. Additionally, such high-power capacitors can be produced in a cost-effective fashion, and barely increase the costs of an X-ray detector due to their very long service life.

According to an embodiment, the X-ray detector has a wireless data transmission unit. This data transmission unit can transmit recorded data of X-ray images to an image processing or control system of an image recording system contactlessly or without bothersome cables, for example by radio communication (e.g. Wi-Fi, WLAN) or via Bluetooth. Here, the data transmission is bidirectional and can relate to both image data (e.g. current image data) from the X-ray detector to the X-ray recording system and calibration data (also images) from the X-ray recording system to the X-ray detector, and also relate to control signals.

According to a further embodiment, the energy supply unit has at least one energy transmission unit for the connection to an external energy transmission system. Such an energy transmission unit can for example have contacts by means of which energy transmission can be brought about in order to recharge the energy supply unit and the high-power capacitor, e.g. from a charging station. Inductive charging is also possible. If necessary, the X-ray detector can be inserted into such a charging station and be recharged.

Advantageously, the X-ray detector has a photovoltaic energy generation device, more particularly at least one solar cell. This additionally enables it to be charged, even independently of an external energy transmission system. However, such a charge generally takes a plurality of hours because solar cells produce lower amounts of energy.

An X-ray recording system according to various embodiments has a mobile X-ray detector with an energy supply unit with a chargeable high-power capacitor, an X-ray source and an energy transmission system for transmitting energy to the energy supply unit of the X-ray detector by means of the energy transmission unit. According to an embodiment, the energy transmission system is formed by a charging station. The X-ray detector can be inserted into such a charging station when it has been discharged, and it can be charged. The charging station can also be provided as a storage unit for the X-ray detector when the latter is not in use. Alternatively or additionally, the energy transmission system can also be arranged in a Bucky drawer or a wall stand.

A significant disadvantage of current mobile X-ray detector technology, more particularly of solid-state or flat-panel detectors, with accumulators is that the recharging process after a partial or complete discharge can take a very long time, namely a few hours. If it is in such a state, the energy supply and hence the continued operation can only be ensured by an electrical connection, for example by a plugged-in cable. However, this no longer allows the wireless connection and completely free movement. Replaceable batteries are used as an alternative. However, this is very impractical in the daily clinical routine and moreover it is cost-intensive.

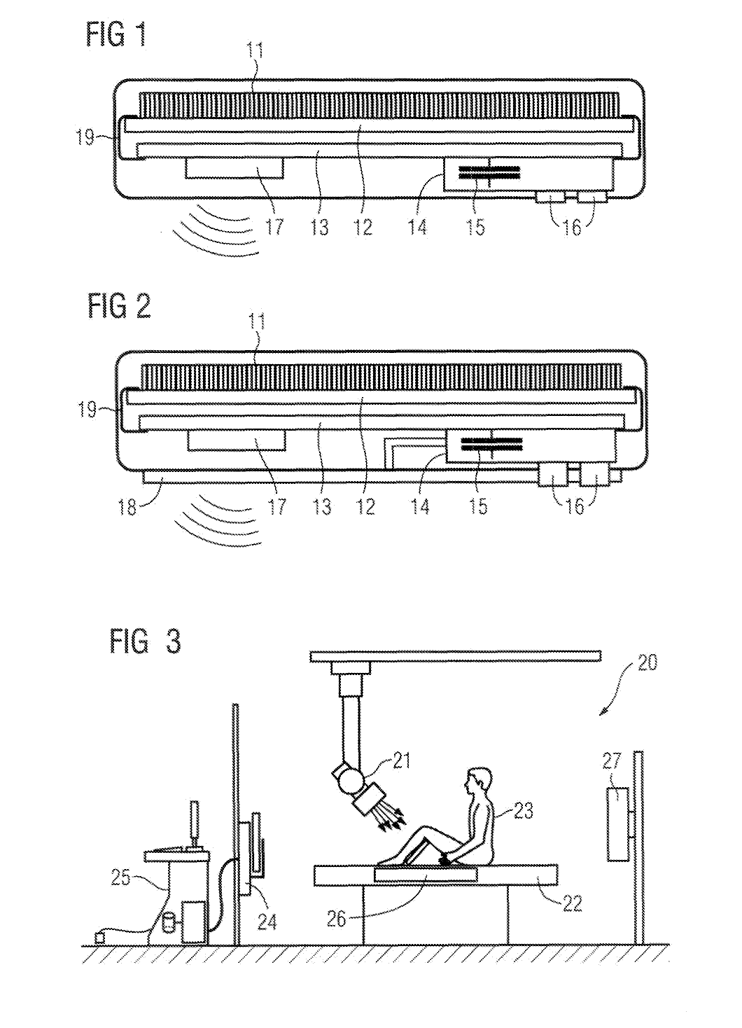

FIG. 1 shows a mobile X-ray detector according to various embodiments, more particularly a solid-state or flat-panel detector, with a structurally integrated energy supply unit 14 containing a high-power capacitor 15. Such a high-power capacitor can be charged very quickly, hardly develops heat and moreover is cost-effective. The X-ray detector also has a scintillator 11 for converting X-ray radiation into light, a photodiode matrix 12 for converting light into electrical charge and for reading out the electrical charge, and an electronics board 13. Additionally, the X-ray detector has a wireless data transmission unit 17 for transmitting e.g. read out image data to an imaging system or a control unit. The data transmission unit can send and receive data on the basis of, for example, radio communication (e.g. WLAN) or Bluetooth. The X-ray detector is designed to be mobile and portable, and is surrounded by a housing 19. In addition to the high-power capacitor 15, which is used for storing energy, the energy supply unit 14 also has contacts 16, which are designed to transmit energy from an external energy transmission system to the high-power capacitor 15.

FIG. 2 shows a further refinement of the X-ray detector with a solar panel 18 made of solar cells for an additional autonomous photovoltaic energy supply. The solar panel can likewise charge the high-power capacitor, for example if the X-ray detector is put down such that light can reach the solar panel. The solar cells can have an inorganic (silicon) or organic design. Depending on the design, such solar cells can, alternatively or additionally, also be attached to the front side; however, high X-ray transparency and radiation hardening are necessary in this case. As an alternative, the X-ray detector is in turn charged by a connection to a charging station via the contacts 16.

FIG. 3 shows an X-ray recording system 20, which has an X-ray source for emitting X-ray radiation, a system control 25 and an energy transmission system in the form of a charging station 24 for charging the associated mobile, wireless X-ray detector 10. The X-ray detector is inserted into the charging station 24 in order to be charged; as a result of its high-power capacitor, it can be recharged within a very short timeframe by means of contact charging e.g. via the contacts 16, and can be reutilized. The charging station can also be used as a storage space for the X-ray detector 10 when the latter is not in use.

The X-ray recording system 20 can also have a patient couch 22, for a patient 23, with a Bucky drawer 26. The Bucky drawer can in turn be designed as a charging station and supply the X-ray detector with energy by means of contacts for as long as the X-ray detector is inserted into the Bucky drawer. This can also occur with the X-ray detector being used at the same time. Additionally, or alternatively, provision can also be made for a wall stand, into which the X-ray detector can be inserted for X-ray recordings and which likewise has an energy transmission system for transmitting energy to the X-ray detector.

In summary: In order to reduce the downtimes for charging, provision is made for an X-ray detector 10 for recording digital X-ray images, which X-ray detector has a mobile design, with a structurally integrated energy supply unit 14 that has at least one chargeable high-power capacitor 15.

What is claimed is:

1. An X-ray detector for recording digital X-ray images, wherein the X-ray detector comprises a mobile design, with an energy supply unit that has at least one chargeable high-power capacitor.

2. The X-ray detector according to claim 1, wherein the X-ray detector has a wireless data transmission unit.

3. The X-ray detector according to claim 1, wherein the energy supply unit has at least one energy transmission unit for the connection to an external energy transmission system.

4. The X-ray detector according to claim 1, wherein the X-ray detector has a wireless design.

5. The X-ray detector according to claim 1, wherein the X-ray detector has a photovoltaic energy generation device, more particularly at least one solar cell.

6. An X-ray recording system, having an X-ray detector comprising a mobile design, with an energy supply unit that has at least one chargeable high-power capacitor, an X-ray source for emitting X-ray radiation and an energy transmission system for transmitting energy to the energy supply unit of the X-ray detector by means of the energy transmission unit.

7. The X-ray recording system according to claim 6, wherein the X-ray detector has a wireless data transmission unit.

8. The X-ray recording system according to claim 6, wherein the energy supply unit has at least one energy transmission unit for the connection to an external energy transmission system.

9. The X-ray recording system according to claim 6, wherein the X-ray detector has a wireless design.

10. The X-ray recording system according to claim 6, wherein the X-ray detector has a photovoltaic energy generation device, more particularly at least one solar cell.

11. The X-ray recording system according to claim 6, wherein the energy transmission system is formed by a charging station.

12. The X-ray recording system according to claim 11, wherein the energy transmission system is arranged in a Bucky drawer or a wall stand.

13. A mobile X-ray detector comprising a solid-state or flat-panel detector, a structurally integrated energy supply unit containing a rechargeable high power capacitor, wherein the X-Ray detector is configured to operate as a potable unit.

14. The mobile X-ray detector according to claim 13, further comprising a scintillator 11, a photodiode matrix, and an electronics board.

15. The mobile X-ray detector according to claim 13, further comprising a wireless data transmission unit.

16. The mobile X-ray detector according to claim 15, wherein the wireless data transmission unit operates according to a wireless local area network or Bluetooth standard.

17. The mobile X-ray detector according to claim 13, wherein the energy supply unit comprises contacts which are configured to transmit energy from an external energy transmission system to the high-power capacitor.

18. The mobile X-ray detector according to claim 13, further comprising a solar panel comprising solar cells, wherein the solar panel is configured to charge the high-power capacitor

19. The mobile X-ray detector according to claim 18, wherein the solar cells have an inorganic or organic design.

20. The mobile X-ray detector according to claim 18, wherein the solar cells are attached to the front side of a housing.
